(19) United States
(12) Patent Application Publication
(10) Pub. No.: US 2007/0160499 A1
(43) Pub. Date: Jul. 12, 2007

(54) Fixture for centrifuging a fluid-containing flexible vessel

(76) Inventor: James F. Mank, Dublin, OH (US)

Correspondence Address: BATTELLE MEMORIAL INSTITUTE, 505 KING AVENUE, COLUMBUS, OH, 43201-2693, US

(21) Appl. No.: 10/572,242

(22) PCT Filed: Sep. 21, 2004
(86) PCT No.: PCT/US04/30868

§ 371 Date: Oct. 3, 2006

Related U.S. Application Data
(60) Provisional application No. 60/504,764, filed on Sep. 22, 2003.

(51) Int. Cl. G01N 9/30

(52) U.S. Cl. 422/72

(57) ABSTRACT

A centrifuging fixture is constructed to hold a fluid-containing flexible vessel during centrifugation of the vessel. The fixture is constructed for attaching to the vessel and supporting the vessel in a manner that is effective during centrifugation to maintain the structural integrity of the vessel and maintain a smooth side wall shape on the portion of the vessel that contains the fluid. In one embodiment, the fixture includes a plurality of side attachment structures for attaching to different locations on the side edge of the vessel in a manner that is effective during centrifugation to maintain the smooth wall shape.

### CROSS-REFERENCE TO RELATED APPLICATION

This application claims the benefit of U.S. provisional application Ser. No. 60/504,764, filed Sep. 22, 2003.

### BACKGROUND OF THE INVENTION

This invention relates in general to biological laboratory devices, and in particular to a fixture for centrifuging a flexible biological fluid-containing processing vessel, or providing density centrifugation of a multi-density fluid.

Flexible vessels, similar to blood bags, can be used in biological suspension processing systems. Process requirements may require centrifugation of the bag contents to separate cells or other relatively dense material from the carrier medium. Normally centrifugation of a suspension is accomplished in rigid centrifuge tubes. It may be undesirable or difficult to transfer the flexible bag contents to traditional centrifuge tubes for performing the centrifugation process because of the volume of fluid involved, because of the personnel time required to make the transfer to multiple centrifuge tubes, because of the potential for loss of sterility of the suspension contained in the flexible bag, or because of the potential risk of exposing the laboratory personnel to the contents. Therefore, centrifugation in the flexible bag may be an attractive alternative, but this alternative introduces its own inherent problems.

Two issues typically occur with flexible bags. Flexible bags are typically made as two-dimensional assemblies, fabricated from two flat sheets that are joined together along sealed side edges. When filled with fluid and placed in a centriflgation bucket, the bags expand to a three-dimensional configuration. The bag's sides and side edges will typically tend to wrinkle as they are filled, and they collapse to an unpredictable shape into the bottom of the centrifuge bucket during centrifugation. Both issues cause problems during centrifugation. When a fluid-filled bag wrinkles or collapses and loses its shape, bag surface irregularities occur that can trap cells or other relatively dense materials during centrifugation. Thus, some of the cells or other dense material collect on the wrinkled surfaces and not where intended, for example, at the low point in the bag. When the bag is removed from the centrifuge bucket, the cells trapped on the surface irregularities can easily be lost during the supernatant removal process because they become resuspended or they are above the predominant interface that forms between the cell pellet and the supernatant.

The patent literature discloses fixtures for holding flexible vessels during centrifugation. For example, U.S. Pat. No. 4,098,456 to Bayham, issued Jul. 4, 1978, discloses attaching an upper edge of a flexible fluid-filled vessel to a fixture, the vessel having holes along its upper edge that mate with pins in the fixture. However, suspending a fluid-filled bag from the top has some drawbacks. High G-forces typically occur during the centrifugation process. If a significant volume of fluid (i.e., weight) is present in the bag, the high apparent bag weight and resulting high suspension force can cause the bag to tear at the suspension point. The fluid can also create high pressure on the bottom and sides of the centrifuged bag; the pressure can be sufficient to cause the bag to stretch or rupture.

U.S. Pat. No. 3,674,197 to Mitchell et al., issued Jul. 4, 1972, discloses an enclosure for a flexible centrifuge bag. The enclosure consists of a juxtaposed pair of half-shells forming a cavity in which the bag is placed. The shells form two apertures on top through which inlet and outlet tubes of the centrifuge bag extend. The positioning of the tubes in the apertures helps to keep the bag in a stabilized position within the enclosure. There is no suggestion to attach the bag to the enclosure.

### SUMMARY OF THE INVENTION

The present invention relates to a centrifuging fixture constructed to hold a fluid-containing flexible vessel during centrifugation of the vessel. The fe is constructed for attaching to the vessel in a manner that is effective during centrifugation to maintain the structural integrity of the vessel and maintain a substantially smooth wall shape at least on the portion of the vessel that contains the fluid.

In a particular embodiment, the invention relates to a fixture constructed to hold a fluid-containing flexible vessel by its side edges during centrifugation of the vessel. The fixture includes a plurality of side edge attachment structures for attaching to different locations on the side edge of the vessel in a manner that is effective during centrifugation to maintain a smooth wall shape on the portion of the vessel that contains the fluid.

The invention also relates to a centrifuging assembly. The assembly includes a flexible vessel for containing a fluid to be centrifuged. The assembly also includes a fixture constructed to hold the vessel during centrifugation of the vessel. The fixture is constructed for attaching to the vessel side edges in a manner that is effective during centrifugation to maintain the structural integrity of the vessel and maintain a substantially smooth wall shape on at least the portion of the vessel that contains the is fluid.

The invention also relates to a centrifuging method. A fluid-containing flexible vessel is held in a fixture by its side edges. The fixture attaches to the vessel in a manner that is effective during centrifugation to maintain the structural integrity of the vessel and maintain a smooth wall shape on the portion of the vessel that contains the fluid. The fixture and the vessel are then centrifuged.

The invention also relates to a method of using a closed process for centrifuging a biological fluid. A sterile and sealed flexible vessel is provided containing a biological fluid to be centrifuged. The sealed vessel is held with a fixture. The fixture attaches to the vessel side edges in a manner that is effective during centrifugation to maintain the structural integrity of the vessel and maintain a smooth wall shape on the portion of the vessel that contains the fluid. The fure and the sealed vessel are then centrifuged. The vessel remains sealed after the centrifugation.

Various advantages of this invention will become apparent to those skilled in the art from the following detailed description of the preferred embodiments, when read in light of the accompanying drawings.

### BRIEF DESCRIPTION OF THE DRAWINGS

FIG. 1 is a perspective view of a centrifuging fixture according to the invention, the fixture comprising first and second mating fixture halves.

FIG. 2 is a side elevational view of one of the fixture halves shown in FIG. 1.

FIG. 3 is a top view of the fixture half shown in FIG. 2.

FIG. 4 is an enlarged view of an edge of the fixture half shown in FIG. 3.

FIG. 5 is a cross-sectional view of the fixture half shown in FIG. 2, illustrating the contour of the fixture cavity.

FIG. 6 is cross-sectional view taken along line 6-6 of FIG. 5.

FIG. 7 is cross-sectional view taken along line 7-7 of FIG. 5.

FIG. 8 is cross-sectional view taken along line 8-8 of FIG. 5.

FIG. 9 is cross-sectional view taken along line 9-9 of FIG. 5.

FIG. 10 is side elevational view of a flexible vessel that can be held and supported by the centrifuging fixture of the invention.

### DETAILED DESCRIPTION OF THE INVENTION

The present invention relates to a centrifugation fixture constructed to hold a fluid-containing flexible vessel by its side edges during centrifugation of the vessel. The fure provides a means to allow successful centrifugation of a suspension within a flexible processing vessel by maintaining the shape of the vessel and preventing wrinkles along any of the sides or side edges of the vessel. Thus, the suspension does not have to be transferred to more traditional centrifugation tubes, and the vessel can remain closed to maintain sterility and sequester the contents to avoid personnel exposure resulting from the fluid transfer.

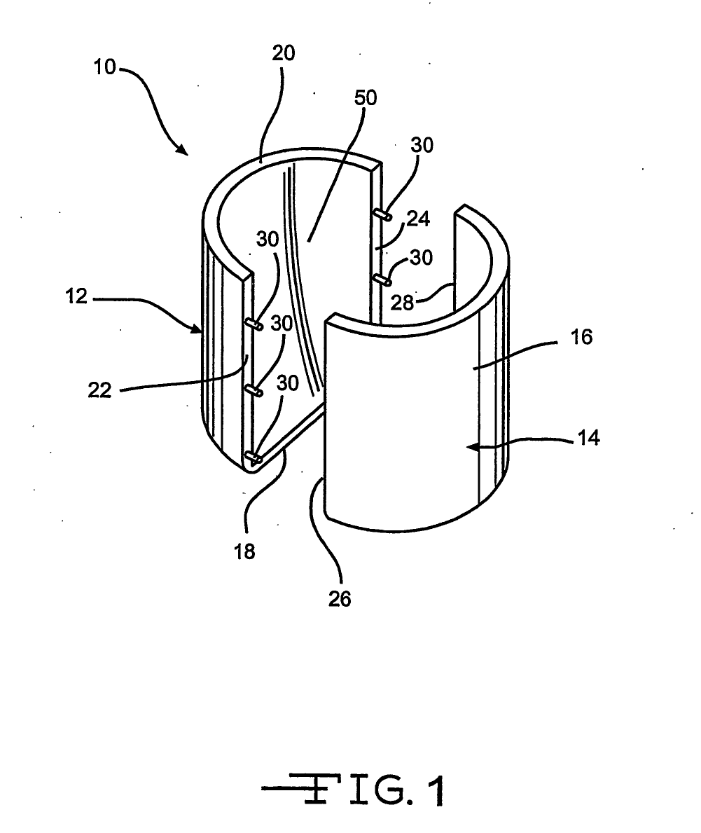

The fixture can have many different forms that are suitable for holding the vessel during centrifugation. FIGS. 1-3 illustrate a preferred embodiment of a fixture 10 according to the invention. The fixture 10 comprises a first fixture portion 12 and a second fixture portion 14. Alternatively, the fixture could be a single-piece fixture or it could consist of more than two portions. In the illustrated embodiment, the first and second fixture portions are mating fixture halves. Together, the fixture halves form a generally cylindrical shell having a closed side 16, a closed bottom 18, and an open top 20. It is preferred that the fixture have a circular cross section, but other cross sections such as oval-shaped can be used for centrifuging depending on the shape of the particular centrifuge bucket. Preferably, the fixture is shaped and sized to be received in a bucket of a centrifuge with the side surface 16 of the fixture fitting closely within the centrifuge bucket. The fixture, being designed to fit closely within the bucket, keeps the fluid-containing vessel in the desired orientation within the bucket. Preferably, the fixture is rotatable within the centrifuge bucket so that the vessel is properly aligned with the bucket pivot axis to obtain optimum distribution of the cells along the bottom edge of the vessel.

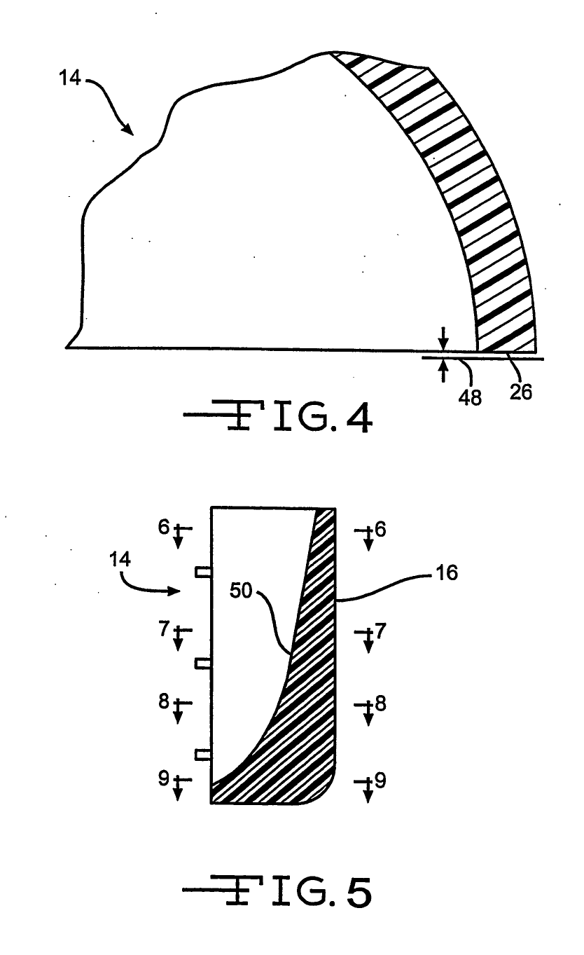

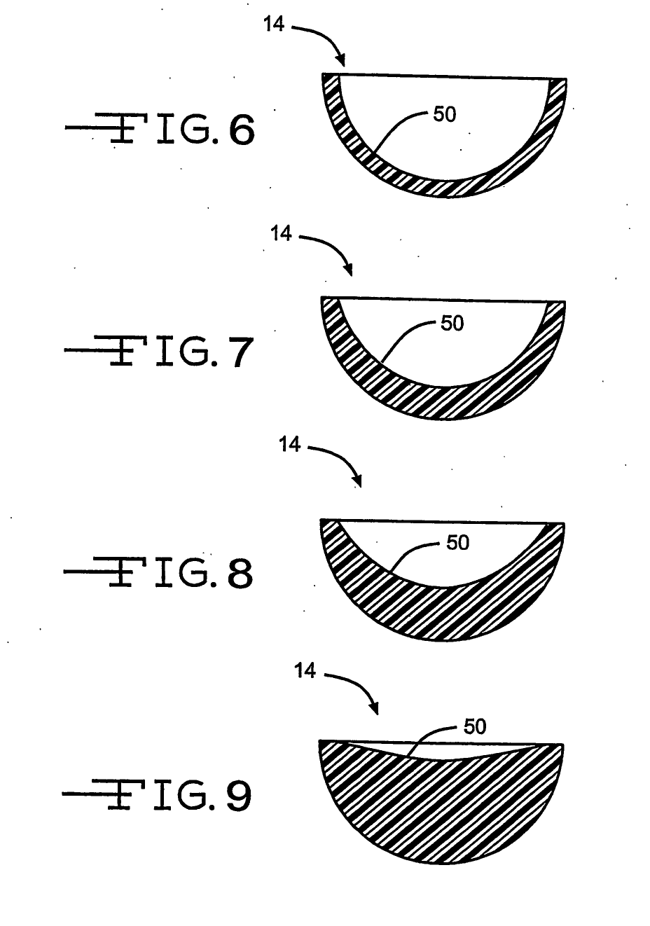

As further seen generally in FIG. 1 and in detail in FIGS. 5-9, the internal surfaces of the preferred fixture of the present invention progress from a generally oval shape at the closed end to a generally round shape at the open end. However, the internal surface design can be varied, depending on the design of the vessel, to provide support in accordance with the present invention for other specific vessel designs.

The fixture is constructed for attaching to vessel side edges in a manner that is effective during centrifugation to maintain a smooth wall shape on the portion of the vessel that contains the fluid. In other words, the vessel does not lose its shape by wrinkling or collapsing during centrifugation. Consequently, the centrifugation process will cause the cells to be evenly distributed along the bottom edge of the vessel and not get captured on wrinkled vessel surfaces that would otherwise exist if the fixture were not used. Any suitable structure can be used for this purpose. In a preferred embodiment, the fixture includes a plurality of side attachment structures for attaching to different locations on the side edge of the vessel in a manner that is effective to maintain the smooth wall shape.

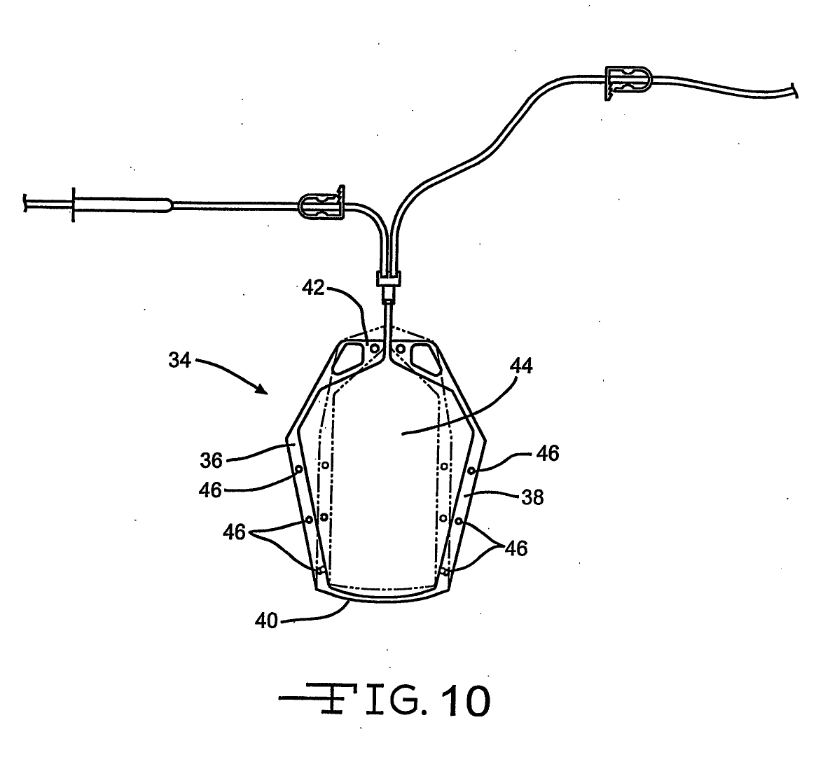

With reference to FIG. 10, the “side” of the vessel (side 44 is shown) refers to any part of the vessel that is between the top and the bottom. The “side edge” (first and second side edges 36, 38 are shown) of the vessel refers to any part of the vessel that extends from a side of the vessel and is that portion of a vessel which is attached or attachable to the fixture 10 in accordance with the present invention. The “top” is the portion closest to the center of rotation during centrifugation, and the “bottom” is the portion furthest from the center of rotation during centrifugation. On a typical flexible vessel for processing biological fluids, the “side” includes both the major side surfaces on opposing sides of the vessel as well as the side edges of the vessel. The side is defined in terms of the orientation of the vessel within the centrifuge. Attaching the fixture to the side edge of the vessel instead of the top is more likely to prevent wrinkling and help it maintain its shape. The walls maintain the structural integrity of the vessel during centrifugation, avoiding tearing, stretching and/or rupturing of the smooth surfaced vessel.

Referring again to FIG. 1, the side attachment structures usually maintain the smooth wall shape by providing a generally balanced holding force around the side of the vessel during centrifugation. This can be accomplished in numerous ways. For example, the fixture can include two attachment structures that attach to substantially opposing locations on the side edges of the vessel, e.g., the opposing side edges of the vessel. The fixture can also include more than two attachment structures that are spaced around the side of the vessel in a manner that provides the generally balanced holding force.

The side attachment structures can have any suitable structure for attaching the fixture to the side edges of the vessel. The side attachment structures can be formed integrally with the fixture, or they can be attached to the fixture. In the preferred embodiment shown in FIGS. 1 and 2, the first fixture portion 12 has first and second edge surfaces 22 and 24, and the second fixture portion 14 has first and second edge surfaces 26 and 28 that mate with the edge surfaces of the first fixture portion. The fixture has side attachment structures comprising pins 30 that are located on the edge surfaces of the first fixture portion, and corresponding holes 32 that are located in the edge surfaces of the second fixture portion. Although the illustrated flure has three pins/holes in the edge surfaces, different numbers of pins and holes can be used. Also, the first fixture portion could have both pins and holes, and second fixture portion would have corresponding holes and pins. The use of the pins and holes to attach to the vessel is described below.

As an alternative to the cooperating pins and holes, the side attachment structures could be cooperating protrusions and grooves on the edge surfaces that are designed to capture side edges of a vessel. Another example could be interlocking edge features on the fixture edge surfaces that spread the attachment force completely across the side edges of a vessel. The fixture can also be structured to hold separate attachment mechanisms, which in turn hold the side edges of the vessel. For example, the attachment mechanisms can be separate grippers that grab the side edges of the vessel, and the grippers are captured by the fixture when it is closed over the vessel. Alternatively, the fixture can hold the side edges of the vessel by clamping them between edge surfaces of the fixture portions. In that case, the edge surfaces of the fixture portions, themselves, constitute the side attachment structures. An irregularity usually present in the side edges of a flexible vessel can facilitate attaching to the vessel by trapping it between close fitting fixture portions. Combinations of these and other methods of attaching to the vessel can also be used.

The fixture of the present invention can further be used for holding any type of fluid-filled flexible vessel. While preferably, the vessel is a biological suspension process vessel, any vessel for use with fluids having mixed density gradients may be considered for use in accordance with the present invention. For example, FIG. 10 shows a flexible vessel 34 suitable for use in the medical field as a transduction vessel. (The solid lines show the vessel before it is filled with fluid, and the dotted lines show the fluid-filled vessel.) The illustrated vessel has opposing first and second side edges 36 and 38, a bottom edge 40, a top edge 42, and opposing first and second sides (first side 44 is shown). The vessel has holes 46 in each of the side edges. The holes in the edges of the vessel correspond with the pins and holes in the edges of the first and second figure portions. To install the vessel in the fixture, the holes in the edges of the vessel are aligned with the pins of the first fixture portion. The vessel is then mounted on the pinned fixture portion by inserting the fixture pins through the holes in the vessel. The second fixture portion with holes is then aligned with the pinned first fixture portion and the two fixture portions are brought together. The opposing side edges of the vessel are held and flattened between the side edges of the first and second fixture portions, and the pins prevent the vessel from moving from between the fixture portions. In an alternative embodiment, the vessel could have pins or protruding features on the side edges that fit into holes or grooves in the side edges of one or both of the fixture portions.

In some applications, it can be advantageous for the fixture to also include a bottom attachment structure for attaching to the bottom of the vessel during centrifugation. For example, attaching to the bottom edge of the vessel may help to prevent the bottom edge from pulling up through the space between the two fixture portions. The bottom attachment structure can be any suitable structure(s), for example pins and corresponding holes along the bottom edges of the fixture portions (not shown), and/or the bottom edge surfaces of the fixture portions could be used for clamping the bottom edge of the vessel. Whether or not attaching to the bottom edge of the vessel is advantageous may be determined by vessel shape, fixture shape, and how full the vessel is to be filled.

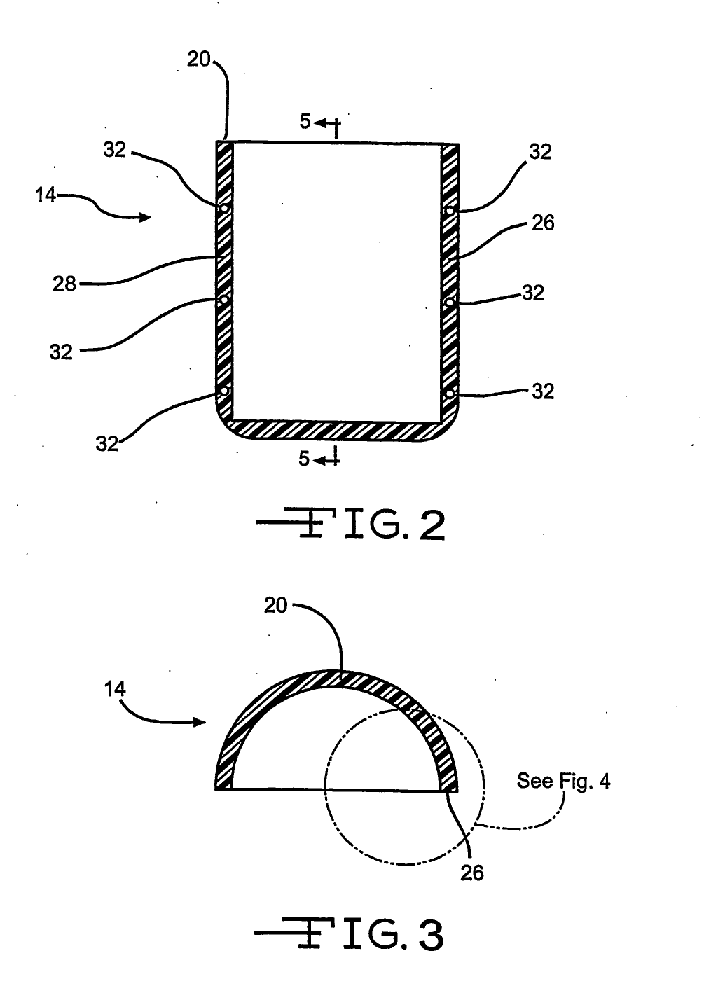

If the fixture is designed to fit closely within the centrifuge bucket without the flexible vessel, the edges of the figure portions can be tried a short distance to provide space for the edges of the vessel to fit between the fixture portions while still allowing the fixture to fit within the bucket. FIG. 4 shows a cross-sectional view of the edge surface 26 of the second fixture portion 14 having been trimmed a short distance 48 to provide clearance for the side edge of the vessel. The clearance can also be achieved by making the outside of the fixture somewhat smaller than the bucket to allow for the thickness of the vessel material.

Preferably, the fiuture is constructed to support the wall of the flexible vessel during centrifugation, at least on the portion of the vessel that contains the fluid. The fixture can have any suitable structure for supporting the flexible vessel. Typically, the fixture has a cavity with a surface that supports the wall of the vessel. As shown in FIGS. 1 and 5, the mating fixture portions 12 and 14 form an interior cavity 50 to receive the flexible vessel. Preferably, the surface of the cavity is shaped and sized to be in contact with substantially all of the wall of the vessel on the portion of the vessel that contains the fluid. The flexible vessel can be shaped in a variety of ways. For example, the bottom edge can range from V-bottomed to flat bottomed. The side edges can be straight and parallel or tapered, depending on the fluid volume in the vessel. Preferably, the shape of the cavity surface is designed to fit the specific vessel shape desired. The cavity surface preferably has a curvature that is shaped and sized to approximate the curvature of the wall of the fluid-containing vessel. In the illustrated embodiment, the cavity surface is curved and tapered, and it converges from top to bottom and from center to sides. This results in a tapered column of fluid in the vessel and causes the cells to be concentrated along the vessel's bottom edge, in the same way as when they are concentrated in the conical shaped portion at the bottom of a centrifuge tube. FIGS. 6-9 illustrate the tapering contour of the surface of the cavity 50.

The invention can provide several advantages over the traditional approach of using centrifuge tubes or of centrifuging unsupported bags:
1. The processed suspension does not have to be transferred to multiple centrifuge tubes before centrifuging.
2. The flexible vessel can remain closed to eliminate the loss of sterility or breach of sterility that can occur during the transfer process.
3. The closed flexible vessel also eliminates contamination of equipment (for example the centrifuge and carriers, etc.) and the facilities, eliminating the need to validate cleaning of equipment otherwise required between patients by FDA regulations.
4. The flexible vessel can remain closed so the laboratory operator is not exposed to the contents.
5. The labor and equipment required to transfer the fluid to centrifuge tubes is eliminated.
6. Surface irregularities in the flexible vessel that could trap cells during the centrifugation process are eliminated.
7. The cells are efficiently concentrated along the bottom edge of the vessel.
8. Large and variable volumes of suspension can be centrifuged in a single flexible vessel.
9. The portion of the flexible vessel that contains fluid is fully supported so the vessel's structural integrity is maintained.

The present invention also relates to a method of using a closed process for processing a biological fluid to be centrifuged. The method involves the steps of: (1) providing a sterile and sealed flexible vessel containing a biological fluid to be centrifuged; (2) holding the sealed vessel with a fixture, the fixture attaching to the vessel in a manner that is effective during centrifugation to maintain the structural integrity of the vessel and maintain a smooth wall shape on the portion of the vessel that contains the fluid; then (3) placing the fixture and the sealed vessel into a centrifuge; and then (4) centrifuging the fixture and the sealed vessel, the vessel remaining sealed after the centrifugation.

In a preferred embodiment, the process includes the additional step of: (5) pressing the centrifuged vessel to transfer supernatant from the vessel to a sterile container, the vessel and the container being connected in a closed system. The pressing step can be performed with any suitable apparatus, such as a press having two press plates that squeeze the supernatant from the vessel. Preferably, the press is constructed so that the supernatant is removed from the vessel while the cell pellet resulting from centrifugation remains contained in the vessel. Typically, this will be, but need not be in all cases, a cell pellet in the bottom of the vessel. In this regard, in the preferred embodiment reference to a “cell pellet” herein is illustrative of a higher density biological material, and is not intended to limit the application. Further, the reference to a “supernatant” is illustrative of any fluid of lower density to be removed from the flexible vessel. The supernatant referred to herein is removed material, wanted or unwanted by the user.

Any suitable components can be used in the closed system in addition to the flexible vessel and the sterile container, as long the components are sterile and as long as they keep the system closed. For example, the components can include sterile connecting devices (SCD) such as SCD tubing and an SCD tubing welder to make connections ascetically between the vessel and the sterile container. The vessel and the sterile container can each have connections that are compatible with the SCD tubing.

Batch biological laboratory processes are often performed in a sterile biological safety cabinet to protect product sterility as various fluids, necessary to the process, are utilized and to protect the operator if the product is hazardous. The process of the invention allows biological processes to be performed in a non-sterile laboratory environment, thereby saving time and money.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

What is claimed is:

1. A centrifuging fixture constructed to hold a fluid-containing flexible vessel during centrifugation of the vessel, and constructed for attaching to vessel side edges in a manner that is effective during centrifugation to maintain the structural integrity of the vessel and maintain a substantially smooth wall shape on the portion of the vessel that contains the fluid.

2. A fixture wherein the fixture includes a plurality of side attachment structures for attaching to different locations on the side edges of the vessel in a manner that is effective during centrifugation to maintain a smooth wall shape on the portion of the vessel that contains the fluid.

3. A fixture according to claim 2 wherein the side attachment structures provide a generally balanced holding force around the side edges of the vessel during centrifugation.

4. A fixture according to claim 3 wherein the side attachment structures are constructed for attaching to substantially opposing locations on the side of the vessel.

5. A fixture according to claim 4 wherein the side attachment structures are constructed for attaching to opposing side edges on the side of the vessel.

6. A fixture according to claim 5 wherein the fixture comprises first and second mating fixture portions, and the side attachment structures comprise pins and corresponding holes in the fixture portions.

7. A fixture according to claim 2 wherein the fixture additionally includes a bottom attachment structure for attaching to the bottom of the vessel.

8. A fixture according to claim 2 wherein the fixture is constructed to support the wall of the vessel on the portion of the vessel that contains the fluid.

9. A fixture according to claim 8 wherein the fixture has a cavity with a surface that is shaped and sized to be in contact with substantially all of the wall of the vessel on the portion of the vessel that contains the fluid.

10. A fixture according to claim 2 wherein the fixture comprises mating fixture portions that form a shell to support the vessel.

11. A fixture according to claim 2 wherein the fixture is shaped and sized to be received in a bucket of the centrifuge with a side surface of the fixture fitting closely within the centrifuge bucket.

12. A fixture according to claim 2 wherein the fixture is rotatable within the centrifuge bucket.

13. A centrifuging assembly comprising:
a flexible vessel for containing a fluid to be centrifuged; and
a fixture constructed to hold the vessel during centrifugation of the vessel, and constructed for attaching to the vessel in a manner that is effective during centrifugation to maintain the structural integrity of the vessel and maintain substantially smooth sides on the portion of the vessel that contains the fluid.

14. An assembly according to claim 13 wherein the fixture includes a plurality of side attachment structures for attaching to different locations on the side edges of the vessel in a manner that is effective during centrifugation to maintain a smooth wall shape on the portion of the vessel that contains the fluid.

15. An assembly according to claim 14 wherein the side attachment structures provide a generally balanced holding force around the side edges of the vessel during centrifugation.

16. An assembly according to claim 14 wherein the fixture additionally includes a bottom attachment structure for attaching to the bottom edge of the vessel.

17. An assembly according to claim 14 wherein the fixture is constructed to support the wall of the vessel on the portion of the vessel that contains the fluid.

18. A centrifuging method comprising:
holding a fluid-containing flexible vessel in a fixture that attaches to the vessel in a manner that is effective during centrifugation to maintain the structural integrity of the vessel and maintain a smooth wall shape on the portion of the vessel that contains the fluid;
placing the fixture and the vessel into a centrifuge; and then
centrifuging the fixture and the vessel.

19. A method of using a closed process for processing a biological fluid to be centrifuged, the method comprising the steps of:
(1) providing a sterile and sealed flexible vessel containing a biological fluid to be centrifuged;
(2) holding the sealed vessel with a fixture, the fixture attaching to the vessel in a manner that is effective during centrifugation to maintain the structural integrity of the vessel and maintain a smooth wall shape on the portion of the vessel that contains the fluid; then
(3) placing the fixture and the sealed vessel into a centrifuge; and then
(4) centrifuging the fixture and the sealed vessel, the vessel remaining sealed after the centrifugation.

20. A method according to claim 19 comprising the additional step of:
(5) transferring fluid from the vessel to a sterile container, the vessel and the container being connected in a closed system.
